(19) United States
(12) Patent Application Publication
(10) Pub. No.: US 2011/0026010 A1
(43) Pub. Date: Feb. 3, 2011

(54) Optical Coherence Tomographic Analysis

(76) Inventor: Dwight Sherod Walker, Durham, NC (US)

Correspondence Address: GLAXOSMITHKLINE;GLOBAL PATENTS, FIVE MOORE DR., PO BOX 13398, MAIL STOP: C.2111F, RESEARCH TRIANGLE PARK, NC, 27709-3398, US

(21) Appl. No.: 12/672,625

(22) PCT Filed: Aug. 7, 2008
(86) PCT No.: PCT/US08/72421

§ 371 Date: Feb. 8, 2010

Related U.S. Application Data
(60) Provisional application No. 60/945,656, filed on Aug. 9, 2007.

(51) Int. Cl. G01J 3/00; G01B 11/02

(52) U.S. Cl. 356/51; 356/497

(57) ABSTRACT

An optical coherence tomographic analysis system for analyzing a pharmaceutical delivery system comprising manufacturing means for manufacturing the pharmaceutical delivery system, the manufacturing means including at least one manufacturing process, and an optical coherence tomographic system having a light source that is adapted to direct a radiation beam to the pharmaceutical delivery system, whereby the radiation beam interacts with the pharmaceutical delivery system, the interaction including the emission of emitted light by the pharmaceutical delivery system, the interferometer being adapted to receive the emitted light from the pharmaceutical delivery system and construct an optical image of the pharmaceutical delivery system from the emitted light in real-time during manufacturing of the pharmaceutical delivery system.

### FIELD OF THE PRESENT INVENTION

The present invention relates generally to methods and systems for analyzing pharmaceutical delivery systems. More particularly, the invention relates to optical coherence tomographic and second harmonic methods and systems for analyzing pharmaceutical delivery systems; particularly, multi-layered pharmaceutical tablets.

### BACKGROUND OF THE INVENTION

As is well known in the art, pharmaceutical delivery systems can comprise various forms, such as tablets, capsules, granules, etc. Tablets are, however, the delivery system which is most widely accepted, since they are more easily administered than capsules and granules.

As is also well known in the art, tablets can comprise various forms, including substantially homogeneous solids, i.e. compacted blends of different components (active agents, lubricants, inactive excipients, etc.). The noted tablets are often coated with a film to aid in oral administration of the tablet (i.e. swallowing) and/or control (or delay) delivery or dissolution of the active agent until the tablet is disposed in a desired region in the gastrointestinal tract.

Tablets can also comprise multi-layered dosage forms having one or more active agents disposed in one or more layers. The noted multi-layered tablets are often referred to as multi-unit tablets.

Many sustained and/or controlled release delivery systems also comprise multi-layered tablets. Illustrative is the sustained released tablet disclosed in Japanese Patent No. 2601660. The sustained release tablet includes (a) a compressed tablet core having an active agent, an insoluble binder and an insoluble filler, (b) a barrier coating formed over the tablet core having a mixture of soluble and insoluble polymers, and a plasticizer, (c) an active coating formed over the barrier coating having the active agent, a soluble polymer and a plasticizer, and (d) a film coating formed over the active coating having a soluble polymer and a plasticizer. The disclosed tablet is thus adapted to provide an initial release of an active agent, a period of no release of the active agent, followed by a substantially constant, zero-order rate of release of the active agent.

As will be readily apparent to one having ordinary skill in the art, notwithstanding the form of a multi-layer tablet, a major factor that can, and in many instances will, influence the delivery or dissolution rate of the active agent (particularly, when disposed in the core or an inner layer) and, hence, the pharmacokinetic (“PK”) characteristics thereof, is the thickness of the employed tablet layers; particularly, outer layers.

Various conventional techniques and processes have been employed to determine the depth or thickness of tablet layers and/or provide three-dimensional images of the tablet structure. Conventional analytical techniques have, however, largely focused on the determination of bulk compositions, while only a few provide spatially-resolved information. Generally, in a conventional technique the material is dissolved and introduced as a solution in the analytical instrument, yielding only average elemental concentrations.

Techniques based on an arc/spark do allow direct solid sampling (of electrically conducting materials) without a digestion step. However, they do not possess the capability to provide accurate spatially resolved analyses, see, e.g., Güther et al., Spectrochim Acta, Part B, vol. 54, p. 381 (1999).

Other techniques, such as Auger or X-ray photoelectron spectrometry, facilitate analysis of surface chemistry on the atomic scale. These techniques can also provide depth-resolved analyses when removing successive layers of material through ion bombardment. As is known in the art, in secondary ion mass spectrometry (“SIMS”), such a bombardment is inherent to the measurement process, as the composition at different depths is inferred from the nature of bombardment-induced secondary ions.

There are several significant drawbacks and disadvantages associated with the techniques referenced above. The noted techniques all involve some preparation of the sample, are time consuming, and require sophisticated and expensive instrumentation.

Further, the sample shape and size is limited by the sample chamber configuration. Some also suffer from limited sensitivity or spatial resolution. For these reasons, they do not meet the industrial needs for on-line, high throughput compositional mapping of heterogeneous materials.

A further technique that has often been employed to analyze tablet layers is laser radiation (or ablation). In laser ablation, a focused laser pulse provides a large power density that transforms a small amount of solid material directly into a vapor plume that is suitable for further analysis. The ability to concentrate laser radiation on a very small surface enables the sampling and analysis of heterogeneous materials with very good lateral resolution (i.e. down to a few micrometers). The separate analysis of successive laser ablation events (at the same position on the solid material) also enables depth-resolved analysis.

However, in order to establish a detailed depth profile, one needs to perform several compositional measurements at different depths in the material. To avoid repeatedly carrying the sample to a separate instrument for the determination of depth, and the subsequent need for precise positioning of the sample in the laser ablation apparatus, typically a pre-established calibration of the crater depth is established on the basis of the cumulative number of laser shots. In this manner, the compositional analysis for a given laser shot is made to correspond to a given depth.

In cases where the sample comprises a coating and a substrate, both having significantly different ablation rates (i.e. ablated depth per laser shot), different calibrations are often employed for the coating and substrate, and an interpolation employed for the interface region. This procedure assumes that the ablation rate is the same for the study sample and the calibration sample, which, in particular, requires sufficient stability of the laser pulse energy and beam radial profile.

The noted technique is, however, limited to relatively simple cases. It would not be applicable for samples where the ablation rate varies in a continuous manner as a function of depth, or to complex multi-layer samples.

It would therefore be desirable to provide a method and system for determining layer depth(s) and/or thickness(es) of multi-layered tablets that can be effectively employed on-line and in real-time.

Drug polymorphism is also an enduring problem in the pharmaceutical industry. Drug polymorphism has implications at many levels, including therapeutic and formulation levels. Thus, the detection and characterization of polymorphism in organic crystals is of considerable importance.

As is well known in the art, different polymorphs of a compound exhibit different physiochemical properties, such as solubility, melting point, hardness, density, crystal shape and optical properties. Most of these properties are important in pharmaceutical development.

The effect of polymorphism on the dissolution rate of an active agent (or pharmaceutical composition) is a particularly important issue. The two principal factors that influence the dissolution rate of an active agent and, hence, absorption into the systemic system are aqueous solubility and gastrointestinal permeability. The noted factors form the basis of the Biopharmaceutical Classification System (BCS), which has been adopted by the U.S. Food and Drug Administration for active agent and/or pharmaceutical composition approval and registration purposes.

Under the BCS, active agents are grouped into four classes; Class I comprising high solubility-high permeability active agents, Class II comprising low solubility-high permeability active agents, Class III comprising high solubility-low permeability active agents, and Class IV comprising low solubility-low permeability active agents.

As will be appreciated by one having ordinary skill in the art, the Class II active agents, having low solubility and high permeability, and, frequently, the Class IV active agents, having low solubility and low permeability, typically exhibit a limited dissolution rate and, hence, absorption. Since polymorphism influences dissolution rate and solubility, different polymorphs of the Class II and IV active agents are very likely to exhibit different absorption profiles.

Polymorphism also influences other areas of pharmaceutical development. By way of example, some polymorphic forms may be easier to produce than others. Further, some polymorphs or amorphous forms may not easily be formulated into tablets.

The use of an unsuitable polymorph can also result in a phase conversion from a metastable to stable polymorph. In suspensions, this can create crystal growth that results in pharmaceutically unacceptable changes in the particle size distribution.

Further, with the advent of combinatorial chemistry, active agent molecules will most likely become larger (i.e. higher molecular weight) and contain more functional groups. The larger molecular weight has several consequences. First, the prevalence of polymorphism will increase, since larger molecules will have greater opportunities to arrange themselves in crystalline lattices and, hence, may be able to crystallize in more polymorphic forms. Second, the active agent will tend to have a higher melting point, which will result in the formation of very stable crystalline structures. The resultant crystalline structures will almost invariably exhibit low aqueous solubility and, thus, increase the prevalence of Class II and IV active agents.

It would therefore be desirable to also provide a method and system for monitoring solid state properties; particularly, crystallinity and polymorphism, of active agents and pharmaceutical delivery systems formed therefrom, e.g., tablets, that can be effectively employed on-line and in real-time.

It is therefore an object of the present invention to provide an improved method and system for determining layer depth(s) and/or thickness(es) of multi-layered tablets that overcomes or substantially reduces the drawbacks and disadvantages associated with prior art methods and systems.

It is another object of the present invention is to provide a method and system for determining layer depth(s) and/or thickness(es) of multi-layered tablets that can be effectively employed on-line and in real-time.

It is another object of the present invention to provide a method and system for monitoring solid state properties; particularly, crystallinity and polymorphism, of active agents and pharmaceutical delivery systems formed therefrom, e.g., tablets, that can be effectively employed on-line and in real-time.

It is another object of the present invention to provide a method and system for determining (i) layer depth(s) and/or thickness(es) and (ii) solid state properties; particularly, crystal structure and polymorphic form (or state), of multi-layered tablets that can be effectively employed on-line and in real-time.

It is another object of the present invention to provide a method and system for substantially simultaneous optical coherence tomographic (“OCT”) and second-harmonic (“SHG”) analysis of multi-layered tablets.

### SUMMARY OF THE INVENTION

In accordance with the above objects and those that will be mentioned and will become apparent below, in one embodiment of the invention, the method for analyzing a pharmaceutical delivery system includes the steps of: (i) providing an optical coherence imaging apparatus having a light source that is adapted to provide a radiation beam having a predetermined wavelength and bandwidth, (ii) transmitting the radiation beam in at least one scanning angle, the radiation beam being directed in first and second paths, the first radiation beam path having a first path length, the first radiation beam path being directed to the pharmaceutical delivery system, whereby the radiation beam interacts with the pharmaceutical delivery system, the interaction including the emission of emitted light by the pharmaceutical delivery system, the second radiation beam path being directed to a reference mirror, (iii) changing the first path length, and (iv) constructing an optical image of the pharmaceutical delivery system from the emitted light.

In another embodiment of the invention, the method for analyzing a pharmaceutical delivery system includes the steps of: (i) providing an optical coherence imaging apparatus having a light source that is adapted to provide a radiation beam having a predetermined wavelength and bandwidth, (ii) transmitting the radiation beam in at least one scanning angle, the radiation beam being directed in first and second paths, the first radiation beam path having a first path length, the second radiation beam path having a second path length, the first radiation beam path being directed to the pharmaceutical delivery system, whereby the radiation beam interacts with the pharmaceutical delivery system, the interaction including the emission of emitted light by the pharmaceutical delivery system, (iii) generating second harmonic light from the emitted light, (iv) determining at least one solid state property of a component, e.g., active agent, disposed in the pharmaceutical delivery system from the second harmonic light, and (v) constructing an optical image of the pharmaceutical delivery system from the emitted light.

In another embodiment of the invention, the method for analyzing a pharmaceutical delivery system includes the steps of: (i) providing an optical coherence imaging apparatus having a light source that is adapted to provide a radiation beam having a predetermined wavelength and bandwidth, (ii) transmitting the radiation beam in at least one scanning angle, the radiation beam being directed in first and second paths, the first radiation beam path having a first path length, the second radiation beam path having a second path length, the first radiation beam path being directed to the pharmaceutical delivery system, whereby the radiation beam interacts with the pharmaceutical delivery system, the interaction including the emission of emitted light by the pharmaceutical delivery system, (iii) generating second harmonic light from the emitted light, (iv) determining at least one solid state property of a component disposed in the pharmaceutical delivery system from the second harmonic light, (v) directing the emitted light to a first multi-optical element that is adapted to selectively pass a predetermined first fraction of the emitted light therethrough, the first light fraction corresponding to the absorbance spectrum of the component, (vi) directing the first fraction of light to a first NIR camera adapted to provide an NIR image of the pharmaceutical delivery system, (vii) and constructing an optical image of the pharmaceutical delivery system from the emitted light.

In one embodiment of the invention, the optical coherence tomographic analysis system for analyzing a pharmaceutical delivery system comprises: (i) manufacturing means for manufacturing the pharmaceutical delivery system, the manufacturing means including at least one manufacturing process, and (ii) an optical coherence imaging apparatus, the optical coherence imaging apparatus including a light source that is adapted to direct a radiation beam having a predetermined wavelength and bandwidth to the pharmaceutical delivery system, whereby the radiation beam interacts with the pharmaceutical delivery system, the interaction including the emission of emitted light by the pharmaceutical delivery system, the optical coherence imaging apparatus being adapted to receive the emitted light from the pharmaceutical delivery system and construct an optical image of the pharmaceutical delivery system from the emitted light in real-time during manufacturing of the delivery system.

In one embodiment, the optical coherence tomographic analysis system includes a processor that is in communication with the manufacturing process and the optical coherence tomographic system, the processor being adapted to generate at least one control signal in response to the emitted light and transmit the control signal to the manufacturing process to regulate the manufacturing process.

In one embodiment of the invention, the optical coherence second harmonic analysis system for analyzing a pharmaceutical delivery system comprises: (i) an optical coherence imaging apparatus having a light source that is adapted to direct a radiation beam having a predetermined wavelength and bandwidth to the pharmaceutical delivery system, whereby the radiation beam interacts with the pharmaceutical delivery system, the interaction including the emission of emitted light by the pharmaceutical delivery system, the optical coherence imaging apparatus being adapted to receive the emitted light from the pharmaceutical delivery system and construct an optical image of the pharmaceutical delivery system from the emitted light, (ii) means for generating second harmonic light, the means for generating second harmonic light being adapted to interact with the emitted light to provide second harmonic light corresponding to at least one solid state property of a component disposed in the pharmaceutical delivery system, and (iii) a multi-optical element that is adapted to selectively pass a predetermined first fraction of the emitted light therethrough, the first light fraction corresponding to the absorbance spectrum of the component.

In another embodiment of the invention, the optical coherence second harmonic analysis system for analyzing a pharmaceutical delivery system comprises: (i) manufacturing means for manufacturing the pharmaceutical delivery system, the manufacturing means including at least one manufacturing process, and (ii) an optical coherence second harmonic analysis system having optical coherence tomographic and second harmonic systems, the optical coherence tomographic system including a light source that is adapted to direct a radiation beam having a predetermined wavelength and bandwidth to the pharmaceutical delivery system, whereby the radiation beam interacts with the pharmaceutical delivery system, the interaction including the emission of emitted light by the pharmaceutical delivery system, the optical coherence tomographic system being adapted to receive the emitted light from the pharmaceutical delivery system and construct an optical image of the pharmaceutical delivery system from the emitted light, the second harmonic system including means for generating second harmonic light from the emitted light, the second harmonic system being adapted to determine at least one solid state property of a component disposed in the pharmaceutical delivery system from the second harmonic light, the construction of the pharmaceutical delivery system optical image and the solid state property determination being performed in real-time during manufacturing of the pharmaceutical delivery system.

In one embodiment of the invention, the optical coherence second harmonic analysis system includes a processor that is in communication with the manufacturing process and the optical coherence tomographic system, the processor being adapted to generate at least a first control signal in response to the emitted light and transmit the first control signal to the manufacturing process to regulate the manufacturing process.

In another embodiment of the invention, the processor is adapted to generate at least a second control signal in response to the second harmonic light and transmit the second control signal to the manufacturing process to regulate the manufacturing process.

In another embodiment, the optical coherence second harmonic system includes a multi-optical element that is adapted to selectively pass a predetermined first fraction of the emitted light therethrough, the first light fraction corresponding to the absorbance spectrum of a component disposed in the pharmaceutical delivery system.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a schematic illustration of one embodiment of an optical coherence tomography (“OCT”) apparatus, according to the invention;

FIG. 2 is a schematic illustration of one embodiment of an optical coherence tomography system, according to the invention;

FIG. 3 is a schematic illustration of one embodiment of an optical coherence second harmonic (“OCTSH”) apparatus, according to the invention;

FIG. 4 is a schematic illustration of one embodiment of an optical coherence second harmonic system, according to the invention; and

FIG. 5 is a NIR transmission spectra for four (4) pharmaceutical delivery system, i.e. multi-layer tablets.

### DETAILED DESCRIPTION OF THE INVENTION

Before describing the present invention in detail, it is to be understood that this invention is not limited to particularly exemplified systems, methods, materials or structures as such may, of course, vary. Thus, although a number of systems and methods similar or equivalent to those described herein can be used in the practice of the present invention, the preferred systems and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a”, “an” and “the” include plural referents unless the content clearly dictates otherwise.

### Definitions

The terms “optical coherence tomography analysis”, “optical coherence tomographic analysis” and “OCT analysis” are used interchangeably herein and are meant to mean and include optical analysis of a sample structure or structure of a pharmaceutical delivery system by optical coherence tomography, including time-domain optical coherence tomography, fourier-domain optical coherence tomography, quantum optical coherence tomography, full field optical coherence tomography, polarization sensitive optical coherence tomography and doppler optical coherence tomography. The noted optical coherence tomographic techniques are described in detail in Tomlins, et al., “Theory, Developments and Applications of Optical Coherence Tomography”, Journal of Applied Physics, Vol. 30, pp. 2519-2535 (2005); which is incorporated by reference herein.

The terms “second harmonic generation” and “second harmonic” are used interchangeably herein and are meant to mean and include the generation of a frequency having at least twice the fundamental frequency i.e. at least 2× the incident wave.

The terms “pharmaceutical composition” and “medicament”, as used herein, are meant to mean and include any substance (i.e., compound or composition of matter) which, when administered to an organism (human or animal) induces a desired pharmacologic and/or physiologic effect by local and/or systemic action. The terms therefore encompass substances traditionally regarded as actives, drugs and bioactive agents, as well as biopharmaceuticals (e.g., peptides, hormones, nucleic acids, gene constructs, etc.) typically employed to treat a number of conditions which is defined broadly to encompass diseases, disorders, infections, and the like. Exemplary pharmaceutical compositions (or medicaments) include, without limitation, antibiotics, antivirals, H2-receptor antagonists, 5HT.sub.1 agonists, 5HT.sub.3 antagonists, COX2-inhibitors, medicaments used in treating psychiatric conditions, such as depression, anxiety, bipolar condition, tranquilizers, medicaments used in treating metabolic conditions, anticancer medicaments, medicaments used in treating neurological conditions, such as epilepsy and Parkinsons Disease, medicaments used in treating cardiovascular conditions, non-steroidal anti-inflammatory medicaments, medicaments used in treating Central Nervous System conditions, and medicaments employed in treating hepatitis. Also included are drugs useful in treating metabolic disorders such as fluoro cyanopyrrolidine compounds, including anhydrate and hydrated forms of such compounds.

A “pharmaceutical composition” can include one or more added materials or constituents, such as carriers, vehicles, and/or excipients. “Carriers,” “vehicles” and “excipients” generally refer to substantially inert materials that are nontoxic and do not interact with other components of the composition in a deleterious manner.

The term “pharmaceutical delivery system”, as used herein, is meant to mean and include a pharmaceutical dosage form that is adapted to administer a pharmaceutical composition (or medicament) to a subject, including, without limitation, tablets, capsules and granules. In one embodiment of the invention described herein, the pharmaceutical delivery system preferably comprises a tablet.

The term “on-line”, as used herein, is meant to mean and include a method or system that can be integrated into or employed during a manufacturing process.

The term “real-time”, as used herein, is meant to mean and include continuous monitoring and/or assessment of a parameter associated with the structure of a sample or structure of a pharmaceutical delivery system, including, without limitation, layer depth and thickness, during a manufacturing process.

The present invention provides optical coherence tomography (“OCT”) based apparatus, systems and methods for analyzing the structure of multi-layered pharmaceutical delivery systems; particularly, tablets. As set forth in detail herein, the OCT based apparatus and systems of the invention are particularly adapted to determine layer depth(s) and/or thickness(es) of multi-layered tablets.

The present invention further provides optical coherence second harmonic (“OCTSH”) based apparatus, systems and methods for analyzing the structure and solid state properties of multi-layered pharmaceutical delivery systems. As is also set forth in detail herein, the OCTSH based apparatus and systems are similarly adapted to determine layer depth(s) and/or thickness(es) of multi-layered tablets. The OCTSH based apparatus and systems are further adapted to monitor and/or analyze, among other solid state properties, crystallinity and polymorphism.

In accordance with one embodiment of the invention (discussed in detail herein), the layer depth and/or thickness of a tablet layer (or layers), and solid state properties of components, e.g. active agent(s), disposed therein, are continuously monitored and/or analyzed during manufacture or processing. The continuous monitoring and/or analysis of the layer depth and/or thickness of the tablet layer (or layers), and solid state properties of components disposed therein, provides quality assurance means to ensure (i) that the desired thickness (and/or depth) of the tablet layer (or layers) is being provided and, hence, that the desired amount of component disposed therein, e.g., active agent, is being provided, and (ii) that the desired solid state properties, such as crystal state and polymorphic form, are exhibited by the components disposed in the tablet; particularly, the active agent(s).

OCT is an emerging non-invasive, three-dimensional “interferometric” technique, which is capable of producing high resolution cross-sectional images through non-homogeneous samples, such as biological tissue. As discussed in detail below, the interferometric technique relies on interference between a split and later re-combined broadband optical field.

Referring first to FIG. 1, there is shown a schematic illustration of one embodiment of an optical coherence tomography (“OCT”) apparatus 10 (referred to interchangeably herein as “OCT apparatus”, “optical coherence imaging apparatus” and “interferometer”) that is particularly suitable for OCT analyses. As illustrated in FIG. 1, the OCT apparatus 10 generally includes a photo detector 12, light source 14, beam splitter 16 and a reference mirror 18.

As further illustrated in FIG. 1, a split field travels in a reference path (denoted generally “15”), reflecting from the reference mirror 14, and also in a sample path (denoted generally “17”) where it is reflected from multiple layers 22 within a sample 20, e.g., multi-layered pharmaceutical delivery system. The reflected optical field is thereafter directed along the detection arm or path (denoted generally “19”) to the photo detector 12, where at least one optical image of the sample 20 is preferably constructed.

Due to the broadband nature of the light, interference between the optical field is only observed when the reference and sample arm optical path lengths are matched to within the coherence length of the light. Therefore, the depth (i.e. axial) resolution of an OCT apparatus (or system) is determined by the temporal coherence of the light source. Sharp refractive index variations between layers in the sample medium manifest themselves as corresponding intensity peaks in the interference pattern.

A time domain interference pattern can be obtained by translating the reference mirror 18 to change the reference path length and match multiple optical paths due to layer reflections within the sample 20. Depth information can also be derived from frequency domain measurements by Fourier transformation of the output spectrum. In such an arrangement the reference optical path length remains fixed and component frequencies of the OCT output are detected using a spectrometer.

In OCT, a two- or three-dimensional image can be obtained by making multiple depth scans. These scans are generally performed while scanning the beam in either one or two orthogonal directions.

OCT has been described mathematically by expressing the electric field E(w, t) as a complex exponential:

E(w, t)=s(w)exp[−i(wt+kz)] (1)

As will be readily apparent to one having ordinary skill in the art, Eq. 1 above is a plane polarized solution to the wave-equation, where source field amplitude spectrum is denoted by s(w), frequency is denoted by w and time variation is denoted as t. The second term in the exponential, in terms of wave number k and distance z, simply accounts for phase accumulated throughout the OCT apparatus or interferometer.

Since the input phase is arbitrary and the OCT apparatus only measures the relative output phase between the two optical paths, the phase term can be dropped from the input electric field. Reference mirror 14 is also assumed to be ideal and the beam splitter 16 has reference and sample arm intensity transmittance, Tᵣ and Tₛ, respectively. Further, the intensity transmission coefficients are related, such that Tᵣ+Tₛ=1.

The sample has a frequency domain response function H(w) that describes its internal structure and accounts for phase accumulation therein. Therefore, the component optical fields can be provided in terms of the input field, i.e.

Eᵢₙ(w,t)=s(w)^{-iwt} (2)

Eᵣ(w,t,Δz)=(TᵣTₛ)^{1/2}Eᵢₙ(w,t)e^{-iφ(Δz)} (3)

Eₛ(w,t)=(TᵣTₛ)^{1/2}Eᵢₙ(w,t)H(w) (4)

Eₒᵤₜ(w,t Δz)=Eᵣ(w,t)+Eₛ(w,t, Δz) (5)

where:
φ (Δz)=the phase accumulated in translating the reference mirror by a geometric distance Δz, which equals Δtc/nₐᵢᵣ.

Thus, φ (Δz) can be determined as follows:

φ (Δz)=2wnₐᵢᵣΔz/c (6)

where:
Δt=optical time of flight difference;
c=the speed of light in vacuum; and
nₐᵢᵣ=the group refractive index of air.

The factor of 2 in Eq. 6 arises because of the particular OCT apparatus configuration, wherein the path length change is always double the distance that the reference mirror is displaced.

The area where OCT analysis is currently attracting the most activity is that of biomedical imaging. Applicant has, however, found that OCT is particularly suited for analysis of pharmaceutical delivery system, i.e. tablet, structures. A unique property of OCT that makes it suitable for analysis of tablet structures is that the depth of penetration is typically considerably deeper than biological samples by virtue of the relatively low attenuation of the light by the sample. That is, since tablets are relatively low in moisture content (in contrast to high moisture biological samples), the absorbance of the pulse by the Matrix is lower, which allows for deeper probing of tablets.

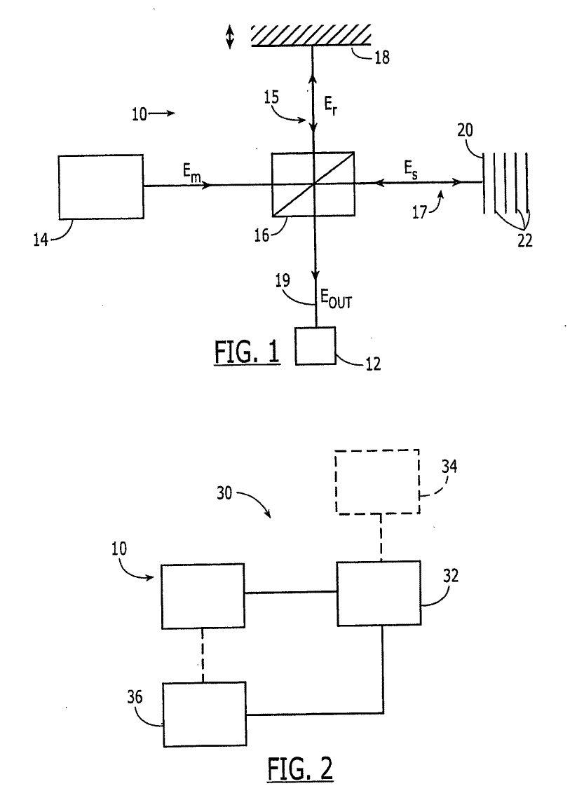

Referring now to FIG. 2, there is shown one embodiment of an OCT system of the invention. As illustrated in FIG. 2, the OCT system (designated generally “30”) includes an OCT apparatus, such OCT apparatus 10 discussed above, a processor 32, which is in communication with the OCT apparatus 10 and the manufacturing process (or controls thereof) 16. According to the invention, the manufacturing process 16 can comprise any acceptable process and/or technique associated with the manufacture of a pharmaceutical delivery system, including, without limitation, granulation, blending and compaction.

In one embodiment of the invention, the manufacturing process 16 includes a transport procedure or step that is adapted to transport at least one, preferably, a plurality of pharmaceutical delivery systems proximate the OCT apparatus 10 for OCT analysis. In another embodiment, the OCT apparatus 10 is disposed proximate a manufacturing sub-system (or processing step), such as a compaction sub-system, whereby the pharmaceutical delivery system(s) can be subjected to OCT analysis during or after the noted manufacturing step or process.

According to the invention, the processor 32 is adapted to receive output from the OCT apparatus 10. The processor 32 is also adapted to process the output transmitted from the OCT apparatus 10, which includes describing the interactions of the optical field with a sample, e.g., pharmaceutical delivery system.

For time domain OCT, wherein the mirror is moved, processing can include, but is not limited to, analysis via the following analytical means (or models): applications of Fresnel's equations, Huygen-Fresnel principles or simply a combination of solutions derived from Maxwell's equations. The noted analytical means and associated models are discussed in detail in Andersen, et al., Phys. Med. Biol., vol. 49, pp. 1307-1327 (2004); Feng, et al., J. Opt. Soc. Am. A, vol. 20, pp. 1792-1803 (2003); Lu, et al., Appl. Opt., vol. 43, pp. 1628-1637 (2004); Smithies, et al., Phys. Med. Biol., vol. 43, pp. 3025-3044 (1998); Tycho, et al., Appl. Opt., vol. 41, pp. 6676-6691; and R. K. Wang, Phys. Med. Biol., vol. 47, pp. 2281-2299; which are incorporated by reference herein.

When a spectrometer is employed in the OCT analysis, such as Fourier-domain OCT, processing can include, but is not limited to, Fourier transform analysis, Hadamard transform analysis and any various wavelet transform analyses. Fourier analysis techniques are set forth in Tomlins, et al., J. Phys. D: Appl. Phys., vol. 38, pp. 2519-2535 (2005); which is incorporated by reference herein.

In some embodiments of the invention, the processor 32 includes display means (shown in phantom and designated 34) for displaying desired generated sample parameters, such as layer depth, layer thickness, etc.

In one embodiment of the invention, the processor 32 is further adapted to generate at least one control signal in response to the reflected optical field (or emitted light) or MOE signal(s), discussed below, and transmit the control signal to the manufacturing process 36 to control at least one aspect thereof. For example, in the event of pharmaceutical delivery system, e.g., tablet, having an out-of-specification layer thickness, the processor 32 can generate and transmit control signals to modify the compaction process and/or divert the pharmaceutical delivery system to a holding or rejection station.

As will be readily apparent to one having ordinary skill in the art, although the manufacturing process 36 and OCT apparatus 10 are shown as separate aspects of the OCT system 30, one or more OCT apparatus 10 can be integrated into the manufacturing process 36. By way of example, in one envisioned embodiment of the invention, an OCT apparatus is integrated into the compaction system and positioned to analyze the structure of the formed pharmaceutical delivery systems, e.g., tablets, after compaction thereof.

In operation, according to one embodiment of the invention, at least one, preferably, a plurality of pharmaceutical delivery system, i.e. tablets, are transported or disposed proximate the OCT apparatus 10 after formation thereof for OCT analysis. Output from the OCT apparatus 10 is transmitted to the processor 32 in real-time, for processing and generation of control signals, if necessary, to control the manufacturing process 36.

In one embodiment of the invention, the OCT analysis comprises time-domain optical coherence tomographic analysis, wherein the light source 14 transmits incident radiation having a wavelength in the range of approximately 750-2500 nm, in another embodiment, in the range of approximately 1000-2000 nm, and in yet another embodiment, approximately 1300 nm. In one embodiment, the incident radiation has a bandwidth in the range of approximately 1000-2000 nm, in another embodiment, in the range of approximately 500-1000 nm, and in yet another embodiment, approximately 70 nm.

In one embodiment, the pulse width of the incident radiation is in the range of approximately 1 fs-1000 ns. In another embodiment, the pulse width of the incident radiation is in the range of approximately 10 fs-100 nm.

In one embodiment of the invention, the noted OCT parameters provide a theoretical resolution (i.e. coherence length) in the range of approximately 1-20 μm. In another embodiment, the OCT parameters provide a theoretical resolution in the range of approximately 1-5 μm.

According to the invention, the light source 14 can comprise various conventional light transmitting mediums, i.e. apparatus and systems, which are adapted to provide broad band light, including, without limitation, light emitting diodes, laser diodes, incandescent lamps, fiber optic amplifiers and Raman shifters. In one embodiment of the invention, the light source comprises a superluminescent diode.

In another embodiment of the invention, the light source 14 comprises a superconinuum laser. The light or incident radiation provided by the noted laser would facilitate higher resolution (i.e. sub 10-micron resolution) OCT images due to its inherent short coherence length.

In yet another embodiment of the invention, the OCT apparatus of the invention include one or more multi-element optical filters (MOE). According to the invention, the filter (or filters) can be incorporated into the light source 14 or disposed within a light path, e.g., sample path 17 (see FIG. 1).

The incorporation of one or more MOEs into an OCT apparatus or interferometer would provide a chemi-specific OCT sensor (and system), which provides rapid, high resolution, chemical and spatial images of samples, including pharmaceutical delivery systems.

Further details relating to multi-element optical filters, and systems and methods employing same, are set forth in pending U.S. Application No. 60/775,395, filed Feb. 21, 2006; which is incorporated by reference herein in its entirety.

In one embodiment of the invention, the method for analyzing the structure of a pharmaceutical delivery system thus includes the steps of: (i) providing an optical coherence imaging apparatus (or OCT apparatus) having a light source that is adapted to provide a radiation beam having a predetermined wavelength and bandwidth, (ii) transmitting the radiation beam in at least one scanning angle, the radiation beam being directed in first and second paths, the first radiation beam path having a first path length, the first radiation beam path being directed to the pharmaceutical delivery system, whereby the radiation beam interacts with the pharmaceutical delivery system, the interaction including the emission of emitted light by the pharmaceutical delivery system, the second radiation beam path being directed to a reference mirror, (iii) changing the first path length, and (iv) constructing an optical image of the pharmaceutical delivery system from the emitted light.

In one embodiment of the invention, the optical coherence tomographic analysis system comprises (i) manufacturing means for manufacturing the pharmaceutical delivery system, the manufacturing means including at least one manufacturing process, and (ii) an optical coherence imaging apparatus, the optical coherence imaging apparatus including a light source that is adapted to direct a radiation beam having a predetermined wavelength and bandwidth to the pharmaceutical delivery system, whereby the radiation beam interacts with the pharmaceutical delivery system, the interaction including the emission of emitted light by the pharmaceutical delivery system, the optical coherence imaging apparatus being adapted to receive the emitted light from the pharmaceutical delivery system and construct an optical image of the pharmaceutical delivery system from the emitted light in real-time during manufacturing thereof.

In one embodiment, the optical coherence tomographic analysis system includes a processor that is in communication with the manufacturing process and the optical coherence tomographic system, the processor being adapted to generate at least one control signal in response to the emitted light and transmit the control signal to the manufacturing process to regulate the manufacturing process.

In yet another embodiment of the invention, one or more solid state properties of at least one component disposed in the pharmaceutical delivery system, e.g., active agent, are determined via the incorporation of second harmonic analysis. As indicated above, the optical coherence second harmonic (“OCTSH”) apparatus and systems of the invention are particularly adapted to analyze and/or determine (i) layer depth(s) and/or thickness(es) of multi-layered tablets and (ii) at least one solid state property of pharmaceutical component disposed therein. In one embodiment, the analysis of the structure and solid state properties is conducted substantially simultaneously.

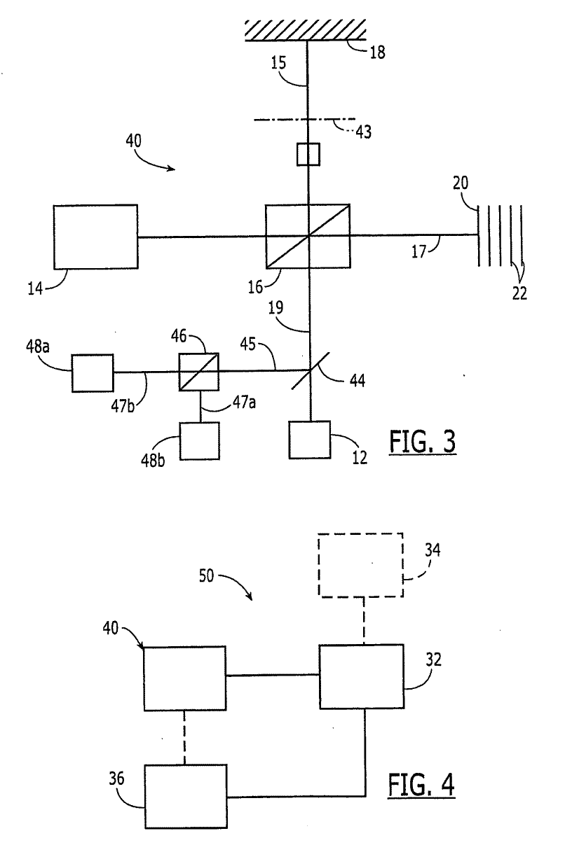

Referring now to FIG. 3, there is shown a schematic illustration of one embodiment of an OCTSH apparatus 40, according to the invention. As illustrated in FIG. 3, the OCTSH apparatus 40 similarly includes the light source 14, beam splitter 16, reference mirror 18 and photo detector 12.

The OCTSH system 40 further includes means for generating second harmonic light. In one embodiment of the invention, the second harmonic light generating means comprises a KDP crystal 42, which is disposed in reference path 15.

According to the invention, a λ/4 wave plate (shown in phantom and designated “43”) can also be disposed in the reference path 15 and positioned after the KDP crystal 42. As will be appreciated by one having ordinary skill in the art, the wave plate 43 can be adjusted so that the reference light transmitted along the reference path 15 is linerarly polarized at 45°. This would facilitate coherent detection of both linear orthogonal polarization states.

The OCTSH apparatus 40 additionally includes a dichroic mirror 44. The dichroic mirror 44 is preferably disposed in the detection path 19 and is adapted (and positioned) to separate the reflected optical field or emitted light (i.e. reflected optical signal) and second harmonic optical signal (denoted generally “45”).

As illustrated in FIG. 3, the reflected optical signal is similarly directed to photo detector 12, where at least one optical image of the sample (or multi-layered pharmaceutical delivery system) 20 is constructed from the optical signal.

According to the invention, the second harmonic optical signal is also directed to at least one detector (e.g., detector 48a), where at least one solid state property of at least one component disposed in the sample 20, e.g., active agent, is determined.

In one embodiment of the invention, the second harmonic optical signal 45 is further separated into orthogonal linear polarization states (denoted generally “47a” and “47b”) by a polarizing beam splitter 46. Each polarization state 47a, 47b is thereafter directed to a respective detector 48a, 48b.

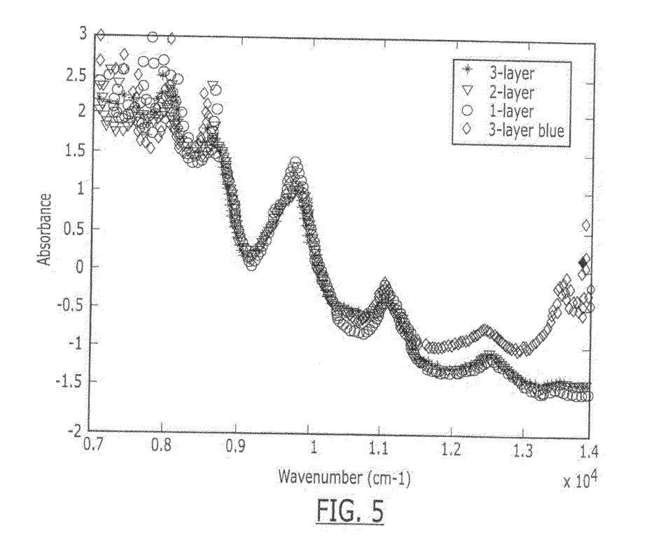

Referring now to FIG. 4, there is shown one embodiment of an OCTSH system of the invention. As illustrated in FIG. 2, the OCTSH system (designated generally “50”) includes an OCTSH apparatus, such as OCTSH apparatus 40, discussed above. The OCTSH system 50 also includes processor 32, which is in communication with the OCTSH apparatus 40, and manufacturing process (or controls thereof) 16. According to the invention, the manufacturing process 16 can similarly comprise any acceptable process and/or technique associated with the manufacture of a pharmaceutical delivery system, including, without limitation, granulation, blending and compaction.

In one embodiment of the invention, the manufacturing process 16 similarly includes a transport procedure or step that is adapted to transport at least one, preferably, a plurality of pharmaceutical delivery systems proximate the OCTSH apparatus 40 for analysis. In another embodiment, the OCTSH apparatus 40 is disposed proximate a manufacturing sub-system (or processing step), such as a compaction sub-system, whereby the pharmaceutical delivery system(s) can be subjected to OCTSH analysis during or after the noted manufacturing step or process.

According to the invention, the processor 32 is adapted to receive output from the OCTSH apparatus 40. The processor 32 is also adapted to process the output transmitted from the OCTSH apparatus 40, which similarly includes describing the interactions of the optical field with a sample, e.g., pharmaceutical delivery system.

In at least one embodiment of the invention, the processor 32 also includes display means (shown in phantom and designated “34”) for displaying desired generated sample and component parameters, such as layer depth, layer thickness, crystal structure and polymorphic state.

The processor 32 is similarly further adapted to generate at least one control signal in response to the reflected optical field and/or MOE signal and/or second harmonic optical signal and transmit the control signal to the manufacturing process 36 to control at least one aspect thereof. In some embodiments, the processor 32 is adapted to generate and transmit a plurality of control signals in response to the reflected optical field and/or MOE signal and/or second harmonic optical signal. For example, in the event of pharmaceutical delivery system, e.g., tablet, having an out-of-specification layer thickness or undesirable crystal structure, the processor 32 can generate and transmit control signals to modify the manufacturing process and/or divert the delivery system to a holding or rejection station.

As will be readily apparent to one having ordinary skill in the art, although the manufacturing process 36 and OCTSH apparatus 40 are shown as separate aspects of the OCTSH system 50, one or more OCTSH apparatus 40 can be integrated into the manufacturing process 36. By way of example, in one envisioned embodiment of the invention, an OCTSH apparatus is integrated into the compaction system and positioned to analyze the structure and/or solid state properties of the formed pharmaceutical delivery systems, e.g., tablets, after compaction thereof.

In operation, according to one embodiment of the invention, at least one, preferably, a plurality of pharmaceutical delivery system, i.e. tablets, are transported or disposed proximate the OCTSH apparatus 40 after formation thereof for OCTSH analysis. Output from the OCTSH apparatus is transmitted to the processor 32 in real-time, for processing and generation of control signals, if necessary, to control the manufacturing process 36.

In one embodiment of the invention, the method for analyzing a pharmaceutical delivery system thus includes the steps of: (i) providing an optical coherence imaging apparatus having a light source that is adapted to provide a radiation beam having a predetermined wavelength and bandwidth, (ii) transmitting the radiation beam in at least one scanning angle, the radiation beam being directed in first and second paths, the first radiation beam path having a first path length, the second radiation beam path having a second path length, the first radiation beam path being directed to the pharmaceutical delivery system, whereby the radiation beam interacts with the pharmaceutical delivery system, the interaction including the emission of emitted light by the pharmaceutical delivery system, (iii) generating second harmonic light from the emitted light, (iv) determining at least one solid state property of a component disposed in the pharmaceutical delivery system from the second harmonic light, and (v) constructing an optical image of the pharmaceutical delivery system from the emitted light.

In another embodiment of the invention, the method for analyzing a pharmaceutical delivery system includes the steps of: (i) providing an optical coherence imaging apparatus having a light source that is adapted to provide a radiation beam having a predetermined wavelength and bandwidth, (ii) transmitting the radiation beam in at least one scanning angle, the radiation beam being directed in first and second paths, the first radiation beam path having a first path length, the second radiation beam path having a second path length, the first radiation beam path being directed to the pharmaceutical delivery system, whereby the radiation beam interacts with the pharmaceutical delivery system, the interaction including the emission of emitted light by the pharmaceutical delivery system, (iii) generating second harmonic light from the emitted light, (iv) determining at least one solid state property of a component disposed in the pharmaceutical delivery system from the second harmonic light, (v) directing the emitted light to a first multi-optical element that is adapted to selectively pass a predetermined first fraction of the emitted light therethrough, the first light fraction corresponding to the absorbance spectrum of the component, (vi) directing the first fraction of light to a first NIR camera adapted to provide an NIR image of the pharmaceutical delivery system, (vii) and constructing an optical image of the pharmaceutical delivery system from the emitted light.

In one embodiment of the invention, the optical coherence second harmonic analysis system comprises: (i) an optical coherence imaging apparatus having a light source that is adapted to direct a radiation beam having a predetermined wavelength and bandwidth to a pharmaceutical delivery system, whereby the radiation beam interacts with the pharmaceutical delivery system, the interaction including the emission of emitted light by the pharmaceutical delivery system, the optical coherence imaging apparatus being adapted to receive the emitted light from the pharmaceutical delivery system and construct an optical image of the pharmaceutical delivery system from the emitted light, (ii) means for generating second harmonic light, the means for generating second harmonic light being adapted to interact with the emitted light to provide second harmonic light corresponding to at least one solid state property of a component disposed in the pharmaceutical delivery system, and (iii) a multi-optical element that is adapted to selectively pass a predetermined first fraction of the emitted light therethrough, the first light fraction corresponding to the absorbance spectrum of the component.

In another embodiment of the invention, the optical coherence second harmonic analysis system includes: (i) manufacturing means for manufacturing a pharmaceutical delivery system, the manufacturing means including at least one manufacturing process, and (ii) an optical coherence second harmonic analysis system having optical coherence tomographic and second harmonic systems, the optical coherence tomographic system including a light source that is adapted to direct a radiation beam having a predetermined wavelength and bandwidth to the pharmaceutical delivery system, whereby the radiation beam interacts with the pharmaceutical delivery system, the interaction including the emission of emitted light by the pharmaceutical delivery system, the optical coherence tomographic system being adapted to receive the emitted light from the pharmaceutical delivery system and construct an optical image of the pharmaceutical delivery system from the emitted light, the second harmonic system including means for generating second harmonic light from the emitted light, the second harmonic system being adapted to determine at least one solid state property of a component disposed in the pharmaceutical delivery system from the second harmonic light, the construction of the pharmaceutical delivery system optical image and the solid state property determination being performed in real-time during manufacturing of the pharmaceutical delivery system.

In one embodiment of the invention, the optical coherence second harmonic analysis system includes a processor that is in communication with the manufacturing process and the optical coherence tomographic system, the processor being adapted to generate at least a first control signal in response to the emitted light and transmit the first control signal to the manufacturing process to regulate the manufacturing process.

In one embodiment of the invention, the processor is adapted to generate at least a second control signal in response to the second generation light and transmit the second control signal to the manufacturing process to regulate the manufacturing process.

In one embodiment, the system includes a multi-optical element that is adapted to selectively pass a predetermined first fraction of the emitted light therethrough, the first light fraction corresponding to the absorbance spectrum of a component disposed in the pharmaceutical delivery system.

In one aspect of the invention, the pharmaceutical delivery system component referenced above comprises an active agent.

### Examples

The. following examples are provided to enable those skilled in the art to more clearly understand and practice the present invention. They should not be considered as limiting the scope of the invention, but merely as being illustrated as representative thereof.

### Example 1

Four (4) pharmaceutical delivery system samples, i.e. tablets, were provided and analyzed via a time-domain OCT apparatus. The samples are summarized in Table I below.

TABLE I

| Sample | | | | |
|---|---|---|---|---|
| No. | Layers | Layer #1 | Layer #2 | Layer #3 |
| 1 | 1 | Opadry ® | | |
| | | yellow¹ | | |
| 2 | 3 | Eudragit ® | Opadry ® | Eudragit ® |
| | | | orange | |
| 3 | 1 | Opadry ® | | |
| | | orange | | |
| 4 | 3 | Opadry ® | denagliptin | Opadry ® |
| | | orange | tosylate | blue |

As set forth in Table I, sample #1 comprised a tablet having one (1) layer of Opadry® yellow (hydroxypropyl methylcellulose, iron oxide, polyethylene glycol, polysorbates 80 and titanium dioxide. Sample #2 comprised a tablet having three (3) applied layers; layers #1 and #3 comprising Eudragit® (polyvinyl pyrollidine and hydroxypropyl methylcellulose) and layer #2 comprising Opadry® orange (hydroxypropyl methylcellulose, titanium dioxide, polyethylene glycol, purified talc, lactose monohydrate, glycerol triacetate, iron oxide red and iron oxide yellow. Sample #3 comprised a tablet having one (1) layer of Opadry® orange. Sample #4 comprised a tablet having three (3) applied layers; layer #1 comprising Opadry® orange, layer #3 comprising Opadry® blue, and layer #2 comprising denagliptin tosylate

Two series of OCT images were produced. The first series was imaged at a high laser power (i.e. 5 mW) to provide greater depth penetration. The second series was imaged at a low laser power (i.e. 1 mW) to provide a greater contrast.

The image of sample #2 clearly reflected a three layer structure. Based on the higher contrast image, the layer thicknesses were determined to be 30 μm, 25 μm and 45 μm thick, from the outermost to innermost layer.

The images of sample #1, sample #3 and sample #4 at high laser intensity, i.e. 5 mW showed one layer, ranging from 30-50 μm thick.

For comparison purposes, microscopy images were also generated. The microscopy images confirmed that sample # is a one structure. The microscopy images also reflected that sample #2 had a three layer structure, sample #3 had a one layer structure and sample #4 had a three layer structure.

Referring now to FIG. 5, there is shown the NIR transmission spectra of the four samples. It should be noted that the y-axis is pseudo, since an appropriate thickness Spectralon standard was not available.

The positive, broad absorbance features represent the harmonics of the fundamental infrared absorbance bands arising for the chemical composition of the ingredients. The sharp features in the spectra, generally in the low wave number region, represent regions of low signal to where the number of photons transmitted is low and hence the signal is more representative of the detector noise.

What is also apparent is that by selecting a different source wavelength, which is better tuned to the absorbance characteristics, better resolution should be possible.

The images generated by the OCT apparatus and discussed above demonstrate that OCT analysis is a viable technique for the nondestructive characterization of tablet structures.

Without departing from the spirit and scope of this invention, one having ordinary skill in the art can make various changes and modifications to the invention to adapt it to various usages and conditions. As such, these changes and modifications are properly, equitably, and intended to be, within the full range of equivalence of the following claims.

What is claimed is:

1. A method for optical imaging of a pharmaceutical delivery system, comprising the steps of:
providing an optical coherence imaging apparatus having a light source, said light source being adapted to provide a radiation beam having a predetermined wavelength and bandwidth;
transmitting said radiation beam in at least one scanning angle, said radiation beam being directed in first and second paths, said first radiation beam path having a first path length, said second radiation beam path having a second path length, said first radiation beam path being directed to said pharmaceutical delivery system, whereby said radiation beam interacts with said pharmaceutical delivery system, said interaction including the emission of emitted light by said pharmaceutical delivery system, said second radiation beam path being directed to a reference mirror;
changing said first path length; and
constructing an optical image of said pharmaceutical delivery system from said emitted light.

2. The method of claim 1, wherein said radiation beam wavelength is in the range of approximately 750-2500 nm.

3. The method of claim 1, wherein said radiation beam wavelength is in the range of approximately 1000-2000 nm.

4. The method of claim 1, wherein said radiation beam bandwidth is in the range of approximately 1000-2000 nm.

5. The method of claim 1, wherein said radiation beam bandwidth is in the range of approximately 500-1000 nm.

6. The method of claim 1, wherein said light source comprises a superluminescent diode.

7. The method of claim 1, wherein said light source comprises a superconinuum laser.

8. The method of claim 1, wherein said pharmaceutical delivery system comprises a tablet.

9. The method of claim 1, wherein said optical image comprises a two-dimensional image of said pharmaceutical delivery system.

10. A method for determining structure and composition information of a pharmaceutical delivery system having at least one active agent, the active agent having an absorbance spectrum, the method comprising the steps of:
providing an optical coherence imaging apparatus having a light source, said light source being adapted to provide a radiation beam having a predetermined wavelength and bandwidth;
transmitting said radiation beam in at least one scanning angle, said radiation beam being directed in first and second paths, said first radiation beam path having a first path length, said second radiation beam path having a second path length, said first radiation beam path being directed to said pharmaceutical delivery system, whereby said radiation beam interacts with said pharmaceutical delivery system, said interaction including the emission of emitted light by said pharmaceutical delivery system, said second radiation beam path being directed to a reference mirror;
directing said emitted light to a first multi-optical element, said first multi-optical element being adapted to selectively pass a predetermined first fraction of said emitted light therethrough, said first light fraction corresponding to the absorbance spectrum of the active agent;
directing said first fraction of light to a first NIR camera adapted to provide an NIR image of the pharmaceutical delivery system; and
constructing an optical image of said pharmaceutical delivery system from said emitted light.

11. The method of claim 10, wherein said radiation beam wavelength is in the range of approximately 750-2500 nm.

12. The method of claim 10, wherein said radiation beam wavelength is in the range of approximately 1000-2000 nm.

13. The method of claim 10, wherein said radiation beam bandwidth is in the range of approximately 1000-2000 nm.

14. The method of claim 10, wherein said radiation beam bandwidth is in the range of approximately 500-1000 nm.

15. The method of claim 10, wherein said light source comprises a superluminescent diode.

16. The method of claim 10, wherein said light source comprises a superconinuum laser.

17. The method of claim 10, wherein said pharmaceutical delivery system comprises a tablet.

18. The method of claim 10, wherein said optical image comprises a two-dimensional image.

19. A method for analyzing a pharmaceutical delivery system having at least one component, comprising the steps of:
providing an optical coherence imaging apparatus having a light source, said light source being adapted to provide a radiation beam having a predetermined wavelength and bandwidth;
transmitting said radiation beam in at least one scanning angle, said radiation beam being directed in first and second paths, said first radiation beam path having a first path length, said second radiation beam path having a second path length, said first radiation beam path being directed to said pharmaceutical delivery system, whereby said radiation beam interacts with said pharmaceutical delivery system, said interaction including the emission of emitted light by said pharmaceutical delivery system;
generating second harmonic light from said emitted light;
determining at least one solid state property of said pharmaceutical delivery system component from said second harmonic light; and
constructing an optical image of said pharmaceutical delivery system from said emitted light.

20. The method of claim 19, wherein said solid state property comprises the crystalline structure of said component.

21. The method of claim 19, wherein said solid state property comprises the polymorphic state of said component.

22. The method of claim 19, wherein said radiation beam wavelength is in the range of approximately 750-2500 nm.

23. The method of claim 19, wherein said radiation beam bandwidth is in the range of approximately 1000-2000 nm.

24. The method of claim 19, wherein said pharmaceutical delivery system comprises a tablet.

25. The method of claim 19, wherein said optical image comprises a two-dimensional image of said pharmaceutical delivery system.

26. A method for analyzing a pharmaceutical delivery system having at least one component, the component having an absorbance spectrum, the method comprising the steps of:
providing an optical coherence imaging apparatus having a light source, said light source being adapted to provide a radiation beam having a predetermined wavelength and bandwidth;
transmitting said radiation beam in at least one scanning angle, said radiation beam being directed in first and second paths, said first radiation beam path having a first path length, said second radiation beam path having a second path length, said first radiation beam path being directed to said pharmaceutical delivery system, whereby said radiation beam interacts with said pharmaceutical delivery system, said interaction including the emission of emitted light by said pharmaceutical delivery system;
generating second harmonic light from said emitted light;
determining at least one solid state property of said component from said second harmonic light;
directing said emitted light to a first multi-optical element, said first multi-optical element being adapted to selectively pass a predetermined first fraction of said emitted light therethrough, said first light fraction corresponding to the absorbance spectrum of said component;
directing said first fraction of light to a first NIR camera adapted to provide an NIR image of the pharmaceutical delivery system; and
constructing an optical image of said pharmaceutical delivery system from said emitted light.

27. The method of claim 26, wherein said component comprises an active agent.

28. The method of claim 26, wherein said pharmaceutical delivery system comprises a tablet.

29. The method of claim 26, wherein said optical image comprises a two-dimensional image of said pharmaceutical delivery system.

30. An optical coherence tomographic analysis system for analyzing a pharmaceutical delivery system having at least one component, the component having an absorbance spectrum, comprising:
an optical coherence imaging apparatus having a light source, said light source being adapted to direct a radiation beam having a predetermined wavelength and bandwidth to said pharmaceutical delivery system, whereby said radiation beam interacts with said pharmaceutical delivery system, said interaction including the emission of emitted light by said pharmaceutical delivery system, said optical coherence imaging apparatus being adapted to receive said emitted light from said pharmaceutical delivery system and construct an optical image of said pharmaceutical delivery system from said emitted light; and
a multi-optical element, said first multi-optical element being adapted to selectively pass a predetermined first fraction of said emitted light therethrough, said first light fraction corresponding to the absorbance spectrum of said component.

31. The system of claim 30, wherein said component comprises an active agent.

32. The system of claim 30, wherein said radiation beam wavelength is in the range of approximately 750-2500 nm.

33. The system of claim 30, wherein said radiation beam bandwidth is in the range of approximately 1000-2000 nm.

34. The system of claim 30, wherein said light source comprises a superluminescent diode.

35. The system of claim 30, wherein said light source comprises a superconinuum laser.

36. The system of claim 30, wherein said pharmaceutical delivery system comprises a tablet.

37. The system of claim 30, wherein said optical image comprises a two-dimensional image of said pharmaceutical delivery system.

38. An optical coherence tomographic analysis system for analyzing a pharmaceutical delivery system during manufacturing thereof, comprising:
manufacturing means for manufacturing said pharmaceutical delivery system, said manufacturing means including at least one manufacturing process; and
an optical coherence imaging apparatus, said optical coherence imaging apparatus including a light source, said light source being adapted to direct a radiation beam having a predetermined wavelength and bandwidth to said pharmaceutical delivery system, whereby said radiation beam interacts with said pharmaceutical delivery system, said interaction including the emission of emitted light by said pharmaceutical delivery system, said optical coherence imaging apparatus being adapted to receive said emitted light from said pharmaceutical delivery system and construct an optical image of said pharmaceutical delivery system from said emitted light in real-time during manufacturing thereof.

39. The system of claim 38, wherein said optical coherence tomographic analysis system includes a processor, said processor being in communication with said manufacturing process and said optical coherence tomographic system, said processor being adapted to generate at least one control signal in response to said emitted light and transmit said control signal to said manufacturing process to regulate said manufacturing process.

40. The system of claim 38, wherein said pharmaceutical delivery system includes at least one component, said component having an absorbance spectrum.

41. The system of claim 40, wherein said optical coherence tomographic analysis system includes a multi-optical element, said first multi-optical element being adapted to selectively pass a predetermined first fraction of said emitted light therethrough, said first light fraction corresponding to said absorbance spectrum of said component.

42. The system of claim 41, wherein said component comprises an active agent.

43. The system of claim 38, wherein said radiation beam wavelength is in the range of approximately 750-2500 nm.

44. The system of claim 38, wherein said radiation beam bandwidth is in the range of approximately 1000-2000 nm.

45. The system of claim 38, wherein said light source comprises a superluminescent diode.

46. The system of claim 38, wherein said light source comprises a superconinuum laser.

47. The system of claim 38, wherein said pharmaceutical delivery system comprises a tablet.

48. The system of claim 38, wherein said optical image comprises a two-dimensional image.

49. An optical coherence second harmonic analysis system for analyzing a pharmaceutical delivery system having at least one component, the component having an absorbance spectrum, comprising:
an optical coherence imaging apparatus having a light source, said light source being adapted to direct a radiation beam having a predetermined wavelength and bandwidth to said pharmaceutical delivery system, whereby said radiation beam interacts with said pharmaceutical delivery system, said interaction including the emission of emitted light by said pharmaceutical delivery system, said optical coherence imaging apparatus being adapted to receive said emitted light from said pharmaceutical delivery system and construct an optical image of said pharmaceutical delivery system from said emitted light;
means for generating second harmonic light, said means for generating second harmonic light being adapted to interact with said emitted light to provide second harmonic light corresponding to at least one solid state property of said component; and
a multi-optical element, said first multi-optical element being adapted to selectively pass a predetermined first fraction of said emitted light therethrough, said first light fraction corresponding to the absorbance spectrum of said component.

50. The system of claim 49, wherein said component comprises an active agent.

51. The system of claim 49, wherein said solid state property comprises the crystalline structure of said component.

52. The system of claim 49, wherein said solid state property comprises the polymorphic state of said component.

53. The system of claim 49, wherein said radiation beam wavelength is in the range of approximately 750-2500 nm.

54. The system of claim 49, wherein said radiation beam bandwidth is in the range of approximately 1000-2000 nm.

55. The system of claim 49, wherein said light source comprises a superluminescent diode.

56. The system of claim 49, wherein said light source comprises a superconinuum laser.

57. The system of claim 49, wherein said pharmaceutical delivery system comprises a tablet.

58. The system of claim 49, wherein said optical image comprises a two-dimensional image of said pharmaceutical delivery system.

59. An optical coherence second harmonic analysis system for analyzing a pharmaceutical delivery system during manufacturing thereof, comprising:
manufacturing means for manufacturing said pharmaceutical delivery system, said manufacturing means including at least one manufacturing process; and
an optical coherence second harmonic analysis system having optical coherence tomographic and second harmonic systems, said optical coherence tomographic system including a light source, said light source being adapted to direct a radiation beam having a predetermined wavelength and bandwidth to said pharmaceutical delivery system, whereby said radiation beam interacts with said pharmaceutical delivery system, said interaction including the emission of emitted light by said pharmaceutical delivery system, said optical coherence tomographic system being adapted to receive said emitted light from said pharmaceutical delivery system and construct an optical image of said pharmaceutical delivery system from said emitted light, said second harmonic system including means for generating second harmonic light from said emitted light, said second harmonic system being adapted to determine at least one solid state property of said pharmaceutical delivery system component from said second harmonic light, said construction of said pharmaceutical delivery system optical image and said solid state property determination being performed in real-time during manufacturing of said pharmaceutical delivery system.

60. The system of claim 59, wherein said optical coherence second harmonic analysis system includes a processor, said processor being in communication with said manufacturing process and said optical coherence tomographic system, said processor being adapted to generate at least a first control signal in response to said emitted light and transmit said first control signal to said manufacturing process to regulate said manufacturing process.

61. The system of claim 60, wherein said processor is adapted to generate at least a second control signal in response to said second harmonic light and transmit said second control signal to said manufacturing process to regulate said manufacturing process.

62. The system of claim 59, wherein said pharmaceutical delivery system includes at least one component, said component having an absorbance spectrum.

63. The system of claim 62, wherein said system includes a multi-optical element, said first multi-optical element being adapted to selectively pass a predetermined first fraction of said emitted light therethrough, said first light fraction corresponding to said absorbance spectrum of said component.

64. The system of claim 63, wherein said component comprises an active agent.

65. The system of claim 59, wherein said radiation beam wavelength is in the range of approximately 750-2500 nm.

66. The system of claim 59, wherein said radiation beam bandwidth is in the range of approximately 1000-2000 nm.

67. The system of claim 59, wherein said light source comprises a superluminescent diode.

68. The system of claim 59, wherein said light source comprises a superconinuum laser.

69. The system of claim 59, wherein said pharmaceutical delivery system comprises a tablet.

70. The system of claim 59, wherein said optical image comprises a two-dimensional image.
